(19) United States
(12) Patent Application Publication
(10) Pub. No.: US 2007/0190882 A1
(43) Pub. Date: Aug. 16, 2007

(54) Laminate and method

(75) Inventors: Ta-Hua Yu, Evansville, IN (US); Guangda Shi, Evansville, IN (US)

Correspondence Address: GEAM - 08CS - STRUCTURED PRODUCTS;IP LEGAL, ONE PLASTICS AVENUE, PITTSFIELD, MA, 01201-3697, US

(73) Assignee: General Electric

(21) Appl. No.: 11/352,863

(22) Filed: Feb. 13, 2006

(51) Int. Cl. B32B 15/08; B32B 15/14

(52) U.S. Cl. 442/232; 442/236

(57) ABSTRACT

Disclosed is a method for preparing a laminate less than or equal to about 98 micrometers in thickness and having substantially diminished curling which comprises the steps of (i) providing a metal foil, a thermoplastic resin film and a woven fabric, and (ii) laminating the thermoplastic resin film between the metal foil and woven fabric, wherein the combination of thermoplastic and fabric has a coefficient of thermal expansion that differs from the coefficient of thermal expansion of the metal foil by less than about 30 ppm. Also disclosed are laminates comprising a thermoplastic resin film between a layer of metal foil and a layer of woven fabric. Also disclosed are laminates consisting of either a polyetherimide film and a woven glass fabric or consisting of a layer of woven glass fabric with a layer of polyetherimide film laminated to each side of the fabric. Articles comprising a laminate of the invention are also disclosed.

### BACKGROUND

The present invention relates to a laminate and a method for making the laminate.

Flexible printed circuit (FPC) has been adapted into numerous electronic applications. Most FPCs are laminates made of a dielectric layer such as a polyimide film, an adhesive layer, and a conductive layer such as copper. However, for highly demanding applications the adhesive layer can cause performance and aging issues, and reduce the reliability of the circuit. For these applications an adhesiveless FPC is needed to improve part reliability. Adhesiveless laminates have been made by such processes as direct metallization but these processes require specialized equipment and high capital investment.

High glass transition temperature polymers (for example, with Tg greater than 200° C.) such as polyetherimides have been proposed for adhesiveless laminate applications due to their thermoplastic nature in that they soften above their glass transition temperature and can be thermally bonded to a metal film. But due to the mismatch in coefficient of thermal expansion (CTE) between common thermoplastic films and metal foil such as copper, this approach is not successful. For example, a typical polyetherimide has CTE greater than 40 ppm/° C. while copper foil has CTE less than 20 ppm/° C. The mismatch in CTE is too great to prepare a laminate without significant level of part distortion such as curling after the thermal lamination process. This curl problem due to CTE mismatch is a problem to be solved in order to use thermoplastic film for applications such as FPC.

In preparing multilayer circuit boards, it is common to form a laminate by impregnation of woven or nonwoven glass, or high temperature polymeric fabrics with thermosetting resins such as epoxy, modified styrene, or polyurethane, to form a prepreg. Normally, the thermosetting resin is partially cured, and a metal foil is placed on one side of the prepreg and subjected to heat to form a bond between metal foil and the prepreg. Multiple prepregs can be used in forming a single composite board. One drawback of using conventional thermosetting resins in the prepregs is they typically have poor electrical properties, for example poor electrical loss characteristics in the 1-100 gigahertz range. Furthermore, typical thermosetting resins are poor in humidity resistance and heat resistance. More recently, poly(tetrafluoroethylene) (PTFE) has been utilized to coat non-woven or woven glass fabrics to replace epoxy resin in the prepregs for high speed digital applications, such as routers, backplanes, mother boards, and daughter boards. These prepregs have been laminated with copper foil via another layer of thermosetting adhesive. This adds to manufacturing process steps or results in other processing inconveniences and/or results in difficulty in reducing an interlayer spacing. Additionally, the thermosetting adhesive has the insufficient heat resistance and dimensional stability problems, similar to those problems exhibited by prepregs made with thermosetting resins. There is a need for laminates comprising metal foil and thermoplastic resin and a method to prepare the laminates, which laminates and method overcome the problems of the prior art such as curling and part distortion.

### BRIEF DESCRIPTION

In one embodiment the invention comprises a method for preparing a laminate less than or equal to about 98 micrometers in thickness and having substantially diminished curling which comprises the steps of (i) providing a metal foil, a thermoplastic resin film and a woven fabric, and (ii) laminating the thermoplastic resin film between the metal foil and woven fabric, wherein the combination of thermoplastic and fabric has a coefficient of thermal expansion that differs from the coefficient of thermal expansion of the metal foil by less than about 30 ppm.

In another embodiment the invention comprises a method for preparing a laminate less than or equal to about 98 micrometers in thickness and having substantially diminished curling which comprises the step of laminating under heat and pressure a polyetherimide resin film between a layer of copper foil and a layer of woven glass fabric, wherein the combination of polyetherimide and fabric has a coefficient of thermal expansion that differs from the coefficient of thermal expansion of the copper foil by less than about 30 ppm.

In another embodiment the invention comprises a laminate less than or equal to about 98 micrometers in thickness and having substantially diminished curling comprising a thermoplastic resin film between a layer of metal foil and a layer of woven fabric, wherein the combination of thermoplastic and fabric has a coefficient of thermal expansion that differs from the coefficient of thermal expansion of the metal foil by less than about 30 ppm.

In another embodiment the invention comprises a laminate less than or equal to about 98 micrometers in thickness and having substantially diminished curling comprising a polyetherimide resin film between a layer of copper foil and a layer of woven glass fabric, wherein the combination of polyetherimide and fabric has a coefficient of thermal expansion that differs from the coefficient of thermal expansion of the copper foil by less than about 30 ppm.

In another embodiment the invention comprises a two-layer laminate less than or equal to about 98 micrometers in thickness consisting of a polyetherimide film and a layer of woven glass fabric, and having a CTE of less than about 45 ppm.

In still another embodiment the invention comprises a three-layer laminate less than or equal to about 98 micrometers in thickness consisting of a layer of woven glass fabric with a layer of polyetherimide film laminated to each side of the fabric, and having a CTE of less than about 45 ppm.

Articles comprising a laminate made in an embodiment of the invention are also encompassed. Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise.

In some embodiments suitable high temperature thermoplastic resins comprise polyimides comprising structural units of the formula (I):

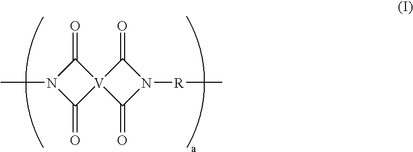

wherein “a” has a value of greater than 1, preferably about 10 to about 1000 or more, and more preferably about 10 to about 500; V is a tetravalent linker without limitation, as long as the linker does not impede synthesis or use of the polyimide; and R is a substituted or unsubstituted divalent organic radical. Suitable linkers include but are not limited to: (a) substituted or unsubstituted, saturated, unsaturated or aromatic monocyclic or polycyclic groups having about 5 to about 50 carbon atoms, (b) substituted or unsubstituted, linear or branched, saturated or unsaturated alkyl groups having 1 to about 30 carbon atoms; or combinations of (a) and (b). Preferred linkers include but are not limited to tetravalent aromatic radicals of formulas (II):

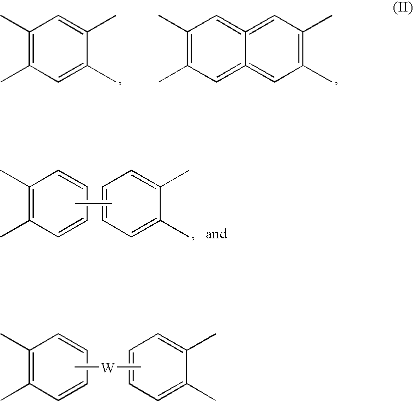

wherein W is a divalent moiety selected from the group consisting of —O—, —S—, —C(O)—, —SO₂—, C_{y}H_{2y}— (y being an integer from 1 to 5), and halogenated derivatives thereof, including perfluoroalkyl groups, or a group of the formula —O-Z-O—, wherein the divalent bonds of the —O— or the —O-Z-O— group are in the 3,3′, 3,4′, 4,3′, or the 4,4′ positions.

In some embodiments the moiety “Z” is a divalent aromatic group derived from a dihydroxy substituted aromatic hydrocarbon, and has the general formula (III):

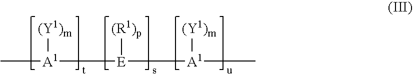

where “A¹” represents an aromatic group including, but not limited to, phenylene, biphenylene, naphthylene, and the like. In some embodiments, “E” may be an alkylene or alkylidene group including, but not limited to, methylene, ethylene, ethylidene, propylene, propylidene, isopropylidene, butylene, butylidene, isobutylidene, amylene, amylidene, isoamylidene, and the like. In other embodiments, when “E” is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments, “E” may be a cycloaliphatic group non-limiting examples of which include cyclopentylidene, cyclohexylidene, 3,3,5-trimethylcyclohexylidene, methylcyclohexylidene, bicyclo[2.2.1]hept-2-ylidene, 1,7,7-trimethylbicyclo[2.2.1]hept-2-ylidene, isopropylidene, neopentylidene, cyclopentadecylidene, cyclododecylidene, and adamantylidene; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹ independently at each occurrence represents a monovalent hydrocarbon group including, but not limited to, alkenyl, allyl, alkyl, aryl, aralkyl, alkaryl, or cycloalkyl. In various embodiments a monovalent hydrocarbon group of R¹ may be halogen-substituted, particularly fluoro- or chloro-substituted, for example as in dihaloalkylidene group of formula C═C(Z¹)₂, wherein each Z¹ is hydrogen, chlorine, or bromine, subject to the provision that at least one Z¹ is chlorine or bromine; and mixtures of the foregoing moieties. In a particular embodiment, the dihaloalkylidene group is a dichloroalkylidene, particularly a gem-dichloroalkylidene group. Y¹ independently at each occurrence may be a non-carbon atom including, but not limited to, halogen (fluorine, bromine, chlorine, iodine); an inorganic group containing more than one non-carbon atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR₂ wherein R² is a monovalent hydrocarbon group including, but not limited to, alkyl, aryl, aralkyl, alkaryl, or cycloalkyl, it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of positions on A¹ available for substitution; “p” represents an integer from and including zero through the number of positions on E available for substitution; “t” represents an integer equal to at least one; “s” represents an integer equal to either zero or one; and “u” represents any integer including zero.

When more than one Y¹ substitutent is present in formula (III), they may be the same or different. The same holds true for the R¹ substitutent. Where “s” is zero in formula (III) and “u” is not zero, the aromatic rings are directly joined by a covalent bond with no intervening alkylidene or other bridge. The positions of the oxygen groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and oxygen groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments of the moiety “Z”, the moiety “E” may comprise an unsaturated alkylidene group. Suitable dihydroxy-substituted aromatic hydrocarbons from which “Z” may be derived in this case include those of the formula (IV):

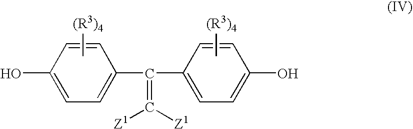

where each R³ is independently at each occurrence hydrogen, chlorine, bromine, or a C₁₋₃₀ monovalent hydrocarbon or hydrocarbonoxy group, and each Z¹ is hydrogen, chlorine or bromine, subject to the provision that at least one Z¹ is chlorine or bromine.

Examples of the moiety “Z” also include those derived from the dihydroxy-substituted aromatic hydrocarbons of the formula (V):

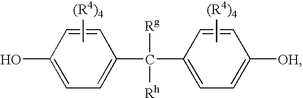

where each R⁴ is independently hydrogen, chlorine, bromine, or a C₁₋₃₀ monovalent hydrocarbon or hydrocarbonoxy group, and R^{g} and R^{h} are independently hydrogen or a C₁₋₃₀ hydrocarbon group.

In various embodiments of the present invention the moiety “Z” may be derived from dihydroxy-substituted aromatic hydrocarbons disclosed by name or formula (generic or specific) in U.S. Pat. Nos. 2,991,273, 2,999,835, 3,028,365, 3,148,172, 3,271,367, and 3,271,368. In some embodiments of the invention, such dihydroxy-substituted aromatic hydrocarbons include bis(4-hydroxyphenyl)sulfide, 1,4-dihydroxybenzene, 4,4′-oxydiphenol, 2,2-bis(4-hydroxyphenyl)hexafluoropropane, and mixtures of the foregoing dihydroxy-substituted aromatic hydrocarbons. In other embodiments, such dihydroxy-substituted aromatic hydrocarbons include 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxy-phenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; resorcinol; C₁₋₃ alkyl-substituted resorcinols; 2,2-bis-(4-hydroxyphenyl)butane; 2,2-bis-(4-hydroxyphenyl)-2-methylbutane; 1,1-bis-(4-hydroxyphenyl)cyclohexane; bis-(4-hydroxyphenyl); 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis-(3,5-dimethylphenyl-4-hydroxyphenyl)methane; 1,1-bis-(3,5-dimethylphenyl-4-hydroxyphenyl)ethane; 2,2-bis-(3,5-dimethylphenyl-4-hydroxyphenyl)propane; 2,4-bis-(3,5-dimethylphenyl-4-hydroxyphenyl)-2-methylbutane; 3,3-bis-(3,5-dimethylphenyl-4-hydroxyphenyl)pentane; 1,1-bis-(3,5-dimethylphenyl-4-hydroxyphenyl)cyclopentane; 1,1-bis-(3,5-dimethylphenyl-4-hydroxyphenyl)cyclohexane; and bis-(3,5-dimethylphenyl-4-hydroxyphenyl)sulfide. In some embodiments suitable dihydroxy-substituted aromatic hydrocarbons further comprise functionality selected from the group consisting of ethers, alkoxys, aryloxys, sulfones, perfluoroalkyl groups and mixtures thereof. In a particular embodiment such a dihydroxy-substituted aromatic hydrocarbon from which Z may be derived comprises bisphenol-A.

In some embodiments “Z” may be derived from dihydroxy-substituted aromatic hydrocarbons wherein “E” is an alkylene or alkylidene group and is part of one or more fused rings attached to one or more aromatic groups bearing one oxygen substitutent. Suitable dihydroxy-substituted aromatic hydrocarbons of this type include those containing indane structural units such as 3-(4-hydroxyphenyl)-1,1,3-trimethylindan-5-ol and 1-(4-hydroxyphenyl)-1,3,3-trimethylindan-5-ol. Also included among suitable dihydroxy-substituted aromatic hydrocarbons of the type comprising one or more alkylene or alkylidene groups as part of fused rings are the 2,2,2′,2′-tetrahydro-1,1′-spirobi[1H-indene]diols, illustrative examples of which include 2,2,2′,2′-tetrahydro-3,3,3′,3′-tetramethyl-1,1′-spirobi[1H-indene]-6,6′-diol (sometimes known as “SBI”). The structures—O-Z-O— derived from dihydroxy-substituted aromatic hydrocarbons may comprise mixtures of structural units derived from mixtures comprising any of the foregoing dihydroxy-substituted aromatic hydrocarbons.

In some particular embodiments Z includes, but is not limited, to divalent radicals of formula (VI):

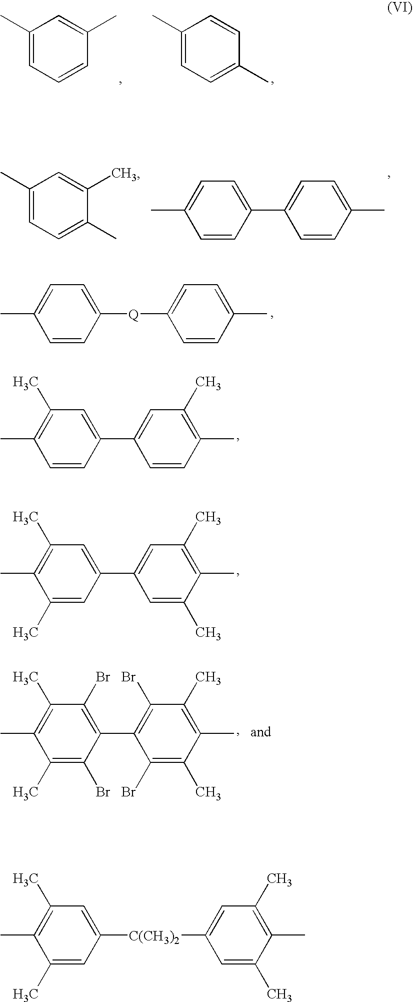

wherein Q includes but is not limited to a divalent moiety selected from the group consisting of —O—, —S—, —C(O)—, —SO₂—, C_{y}H_{2y}— (y being an integer from 1 to 5), and halogenated derivatives thereof, including perfluoroalkyl groups such as but not limited to —C(CF₃)₂—.

In some particular embodiments the moiety R in formula (I) comprises substituted or unsubstituted divalent organic radicals such as: (a) aromatic hydrocarbon radicals having about 6 to about 20 carbon atoms and halogenated derivatives thereof, (b) straight or branched chain alkyl radicals having about 2 to about 20 carbon atoms; (c) cycloalkyl radicals having about 3 to about 20 carbon atoms, or (d) divalent radicals of the general formula (VII):

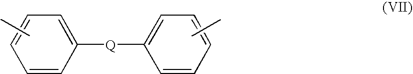

wherein Q includes but is not limited to a divalent moiety selected from the group consisting of a covalent bond, —O—, —S—, —C(O)—, —SO₂—, C_{y}H_{2y}— (y being an integer from 1 to 5), and halogenated derivatives thereof, including perfluoroalkyl groups such as but not limited to —C(CF₃)₂—, and wherein the variable linking bonds shown in formula (VII) are in the 3,3′, 3,4′, 4,3′, or the 4,4′ positions.

In other particular embodiments the moiety R is formally derived from at least one diamine. Illustrative examples of suitable diamines comprise ethylenediamine, propylenediamine, trimethylenediaamine, diethylenetriamine, triethylenetertramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, bis(3-aminopropyl)sulfide, 1,4-cyclohexanediamine, bis-(4-aminocyclohexyl)methane, and 1,3-bis(3-aminopropyl)tetramethyldisiloxane.

The preferred diamino compounds from which the moiety R may be formally derived are aromatic diamines. Illustrative examples of suitable aromatic diamines comprise aromatic diamines, illustrative examples of which include, but are not limited to, meta-phenylene diamine, para-phenylene diamine, 2,6-diethyl-4-methyl-1,3-phenylene diamine, 2,4-diaminotoluene, 2,6-diaminotoluene, 2,6-bis(mercaptomethyl)-4-methyl-1,3-phenylenediamine, 4,6-bis(mercaptomethyl)-2-methyl-1,3-phenylene diamine, bis(2-chloro-4-amino-3,5-diethylphenyl)methane, 4,4′-oxydianiline, 3,4′-oxydianiline, 3,3′-oxydianiline, 1,2-bis(4-aminophenyl)cyclobutene-3-4-dione, 1,3-bis(3-aminophenoxy)benzene, 1,3-bis(4-aminophenoxy)benzene, 1,4-bis(4-aminophenoxybenzene), 3,3′-diaminodiphenylsulfone, 4,4′-diaminodiphenylsulfone, bis(4-(4-aminophenoxy)phenyl)sulfone, bis(4-(3-aminophenoxy)phenyl)sulfone, 4,4′-bis(3-aminophenoxy)biphenyl, 4,4′-bis(4-aminophenoxy)biphenyl, 2,2′-bis(4-(4-aminophenoxy)phenyl)propane, 2,2-bis[4-(4-aminophenoxy)phenyl]hexafluoropropane, 4,4′-bis(aminophenyl)hexafluoropropane, 3,3′-diaminobenzophenone, 4,4′-diaminodiphenylmethane, 4,4′-diaminodiphenyl ether, 3,3′-diaminodiphenylmethane, benzidine, 3,3′-dimethylbenzidine, 3,3′-dimethoxybenzidine, 4,4′-diaminodiphenylsulfide, 2,2′-bis(4-aminophenyl)propane, bis(p-beta-methyl-o-aminophenyl)benzene, 1,3-diamino-4-isopropylbenzene, 1,2-bis(3-aminophenoxy)ethane, diaminobenzanilide, aminophenoxy biphenyl, bis(aminophenoxy)phenyl sulfone, bis aminophenoxy benzene, bis(p-beta-amino-t-butylphenyl)ether, 1,5-diaminonaphthalene, 2,4-bis(beta-amino-t-butyl)toluene, bis aminophenoxy fluorene, p-xylylenediamine, 5-methyl-4,6-diethyl-1,3-phenylene-diamine, bis(p-b-methyl-o-aminopentyl)benzene, and m-xylylenediamine. Mixtures of diamines can also be used. For example, the ETHACURE diamines, such as ETHACURE 100, which is a 80:20 weight ratio combination of 2,6-diethyl-4-methyl-1,3-phenylene diamine and 4,6-diethyl-2-methyl-1,3-phenylene diamine, respectively, and ETHACURE 300 which is a 80:20 weight ratio combination of 2,6-bis(mercaptomethyl)-4-methyl-1,3-phenylenediamin-e and 4,6-bis(mercaptomethyl)-2-methyl-1,3-phenylene diamine, respectively, can also be used. In some embodiments the preferred diamino compounds are aromatic primary diamines free of benzylic hydrogens, especially m- and p-phenylenediamine, diaminodiphenyl sulfone and mixtures thereof. In some embodiments the organic diamines may comprise functionality selected from the group consisting of ethers, alkoxys, aryloxys, sulfones and perfluoro alkyl groups, and mixtures thereof.

In some particular embodiments the structural elements of formula (I) may be formally derived from at least one organic diamine and at least one aromatic dianhydride. Illustrative examples of aromatic dianhydrides comprise diphenyl sulfone tetracarboxylic dianhydride, diphenyl sulfide tetracarboxylic dianhydride, hydroquinone diphthalic anhydride, resorcinol diphthalic anhydride, 2,2-bis(4-(3,4-dicarboxyphenoxy)phenyl)propane dianhydride, 4,4′-bis(3,4-dicarboxyphenoxy)diphenyl ether dianhydride, 4,4′-bis(3,4-dicarboxyphenoxy)diphenyl sulfide dianhydride, 4,4′-bis(3,4-dicarboxyphenoxy)benzophenone dianhydride, 4,4′-bis(3,4-dicarboxyphenoxy)diphenyl sulfone dianhydride, 2,2-bis([4-(2,3-dicarboxyphenoxy)phenyl]propane dianhydride, 4,4′-bis(2,3-dicarboxyphenoxy)diphenyl ether dianhydride, 4,4′-bis(2,3-dicarboxyphenoxy)diphenyl sulfide dianhydride, 4,4′-bis(2,3-dicarboxyphenoxy)benzophenone dianhydride, 4,4′-bis(2,3-dicarboxyphenoxy)diphenyl sulfone dianhydride, 4-(2,3-dicarboxyphenoxy)-4′-3,4-dicarboxyphenoxy)diphenyl-2,2-propaane dianhydride, 4-(2,3-dicarboxyphenoxy)-4′-(3,4-dicarboxyphenoxy)diphenyl ether dianhydride, 4-(2,3-dicarboxyphenoxy)-4′-(3,4-dicarboxyphenoxy)diphenyl sulfide dianhydride, 4-(2,3-dicarboxyphenoxy)-4′-(3,4-dicarboxyphenox-y)benzophenone dianhydride, 4-(2,3-dicarboxyphenoxy)-4′-(3,4-dicarboxyphen-oxy)diphenyl sulfone dianhydride, bisphenol-A dianhydride, benzophenone dianhydride, pyromellitic dianhydride, biphenylene dianhydride and oxydiphthalic anhydride, as well as mixtures thereof. Most preferred dianhydrides are bisphenol-A dianhydride, benzophenone dianhydride, pyromellitic dianhydride, biphenylene dianhydride or oxydiphthalic anhydride. Other illustrative examples of some specific aromatic dianhydrides are disclosed, for example, in U.S. Pat. No. 3,972,902.

In particular embodiments suitable polyimides comprise thermoplastic polyimides such as, but not limited to, AURUM® polyimide prepared by reacting 4,4′-bis(3-aminophenoxy)biphenyl with pyromellitic dianhydride and available from Mitsui Chemicals America; NASA Langley Research Center thermoplastic polyimide (LARC-TPI); NASA Langley Research Center crystallizable polyimide (LARC-CPI); UPILEX® polyimide available from Ube Industries; or APICAL® polyimide available from Kaneka Corporation, Japan. Some other examples of suitable thermoplastic polyimides may be found in U.S. Pat. Nos. 4,847,311, 6,103,806, and 6,458,912.

Preferred classes of polyimide polymers include poly(amideimide) polymers and polyetherimide polymers, particularly those polyetherimide polymers known in the art which are melt processable. The most preferred polyimide resins are polyetherimides or copolymers comprising both polyimide and polyetherimide structural units.

Preferred polyetherimide resins comprise more than 1, preferably about 10 to about 1000 or more, and more preferably about 10 to about 500 structural units, of the formula (VIII):

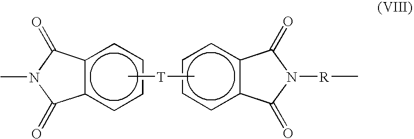

wherein T is —O— or a group of the formula —O-Z-O— wherein the divalent bonds of the —O— or the —O-Z-O— group are in the 3,3′, 3,4′, 4,3′, or the 4,4′ positions, and wherein Z is as defined hereinabove.

In one embodiment the polyetherimide may be a copolymer, which, in addition to the etherimide units described above, further contains polyimide structural units of the formula (IX):

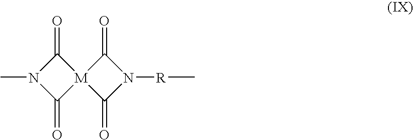

wherein R is as previously defined for formula (I) and M includes, but is not limited to, radicals of formula (II), given hereinabove.

In some embodiments polyetherimides have at least 50 mole % imide linkages derived from an aromatic bis(ether anhydride) that is an oxy diphthalic anhydride or the reactive equivalent thereof. Oxy diphthalic anhydrides may be represented by the formula (X):

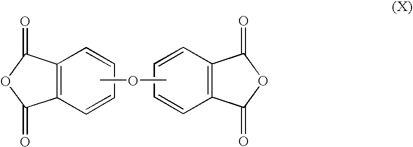

and derivatives thereof. Illustrative oxy diphthalic anhydrides comprise 4,4′-oxybisphthalic anhydride, 3,4′-oxybisphthalic anhydride, 3,3′-oxybisphthalic anhydride, and mixtures thereof. In a particular embodiment a polyetherimide comprises from about 60 mole % to about 100 mole % oxy diphthalic anhydride derived imide linkages, in an alternative embodiment from about 70 mole % to about 99 mole % oxy diphthalic anhydride derived imide linkages, and in yet another embodiment from about 80 mole % to about 97 mole % oxy diphthalic anhydride derived imide linkages, and ranges there between, based on the moles of dianhydride derived structural units present in the polyetherimide.

Certain polyetherimides herein comprise structural units formally derived from combination of one or more dianhydrides with an organic diamine of the formula (XI):
H₂N—R—NH₂ (XI)

wherein R is defined as described above in formula (I). In some embodiments melt processable polyimides may be made by reaction of more or less equal molar amounts of dianhydride, or chemical equivalent with a diamine containing a flexible linkage. In some cases the amount of dianhydride and diamine amine should differ by less than 5 mole %.

Copolymers of polyetherimides which include structural units derived from imidization reactions of mixtures of the oxy diphthalic anhydrides listed above having two, three, or more different dianhydrides, and a more or less equal molar amount of an organic diamine with a flexible linkage, are also within the scope of the invention. In addition, copolymers that have at least about 50 mole % imide linkages derived from oxy diphthalic anhydrides defined above, which includes derivatives thereof, and up to about 50 mole % of alternative dianhydrides distinct from oxy diphthalic anhydride are also contemplated. That is, in some instances copolymers, in addition to having at least about 50 mole % linkages derived from oxy diphthalic anhydride, will also include imide linkages derived from aromatic dianhydrides different than oxy diphthalic anhydrides such as, for example, bisphenol A dianhydride (BPADA), disulfone dianhydride, benzophenone dianhydride, bis(carbophenoxy phenyl)hexafluoro propane dianhydride, bisphenol dianhydride, pyromellitic dianhydride (PMDA), biphenyl dianhydride, sulfur dianhydride, sulfo dianhydride and mixtures thereof. In some embodiments polyetherimides comprising structural units derived from an oxy diphthalic anhydride have a glass transition temperature (Tg) of about 270° C. or higher, and melt viscosity in a range of from about 200 Pascal-seconds to about 10,000 Pascal-seconds at 425° C. as measured by ASTM method D3835.

In another embodiment polyetherimides comprise structural units derived from imidization reactions of at least one dianhydride and a more or less equal molar amount of at least one organic diamine as described above where the organic diamine includes an aryl diamine containing a flexible linkage. For example, a homopolymer which is the reaction product of 100 mole % oxy diphthalic anhydride and 100 mole % aryl diamine is within the scope of the invention. In addition, copolymers containing 100 mole % imide linkages derived from oxy diphthalic anhydride and two or more aryl diamines, or copolymers described above having imide linkages derived from two or more dianhydrides, including at least about 50 mole % oxy diphthalic anhydride, and at least one aryl diamine are also contemplated.

In another embodiment at least about 50 mole % of the imide linkages of the polyetherimide are sulfone linkages. In such case a portion of at least one of the aromatic dianhydride reactants or diamine reactants which forms the polyetherimide composition, includes a sulfone linkage. In one embodiment the polyetherimide includes structural units that are derived from an aryl diamino sulfone of the formula (XII):
H₂N—Ar—SO₂—Ar—NH₂ (XII)

wherein Ar can be an aryl group containing a single or multiple rings. Several aryl rings may be linked together, for example through ether linkages, sulfone linkages or more than one sulfone linkage. The aryl rings may also be fused.

In another embodiment the polyetherimide includes at least one aryl ether linkage derived from oxy diphthalic anhydride as defined above and at least one aryl sulfone linkage. The diamine employed in the synthesis of the polyetherimide composition can comprise at least about 50 mole % of aryl diamino sulfone, in an alternative embodiment from about 50 mole % to about 100 mole % aryl diamino sulfone, in another alternative embodiment from about 70 mole % to about 100 mole % aryl diamino sulfone, and in yet another embodiment from about 85 mole % to about 100 mole % aryl diamino sulfone, and ranges therebetween, based on the moles of aryl diamino sulfone used to form the polyetherimide. In one example at least 50 mole % of the repeat units of the polyetherimide contains one aryl ether linkage and one aryl diamino sulfone linkage. In a particular embodiment a suitable polyetherimide comprises structural units derived from BPADA and 4,4′-diaminodiphenylsulfone.

In alternative embodiments, the amine groups of the aryl diamino sulfone can be meta or para to the sulfone linkage, for example, as in formula (XIII):

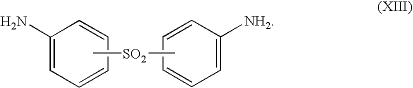

Such aromatic diamines include, but are not limited to, diamino diphenyl sulfone, particularly 4,4′-diaminodiphenylsulfone (DDS), and bis(aminophenoxy phenyl)sulfones (BAPS). The oxy diphthalic anhydrides described above may be used to form polyimide linkages by reaction with an aryl diamino sulfone to produce polyetherimide sulfones.

In another embodiment a polyetherimide copolymer comprises structural units derived from aryl diamino sulfone and from about 50-85 mole % oxydiphthalic anhydride and from about 15-50 mole % of bisphenol A dianhydride or “BPADA”, based on the collective moles of dianhydride derived units present. Oxydiphthalic anhydride/bisphenol A dianhydride (OPDA/BPADA) copolymers comprising additional aromatic dianhydrides and two or more aryl diamino sulfones are also contemplated. In one embodiment copolymers may be derived from two or more dianhydrides where at least about 50 mole % imide linkages are derived from oxy diphthalic anhydride and two or more diamines, provided that at least 50 mole % of the diamines have flexible linkages and the polyimide made from them is melt processable with a Tg of at least about 270° C. Copolymers may be made reacting a mixture of aryl diamines with oxydiphthalic anhydride. For instance a mixture of 4,4′-diamino diphenyl sulfone may be combined with 3,3,′-diamino diphenyl sulfone. In addition mixtures of several dianhydrides and several diamines may be used in so far that at least 50 mole % of the imide linkages in the polymer are derived from oxy diphthalic anhydride and said imide linkages have at least one other flexible linkage. Examples of a second flexible linkage include, but are not limited to, ethers, sulfones and sulfides.

Illustrative polyetherimides and methods to make them are disclosed, for example, in U.S. Pat. Nos. 3,787,364, 3,803,085, 3,847,867, 3,847,869, 3,850,885, 3,852,242, 3,855,178, 3,905,942, 3,917,643, 3,983,093, 4,689,391, 4,835,249, 4,965,337, 5,229,482, 5,830,974, and 6,849,706, and in U.S. published Patent Applications 20040249117, 20050049390 and 20050070684.

In other embodiments suitable high temperature thermoplastic resins comprise polyarylsulfones. Illustrative examples of suitable polyarylsulfones and methods to prepare them include, but are not limited to, those as described in U.S. Pat. Nos. 4,065,437, 4,108,837, 4,175,175, 4,839,435, 5,434,224, and 6,228,970. Some particular examples of suitable polyarylsulfones comprise polyphenylsulfones which comprise structural units of the formula (VIII):

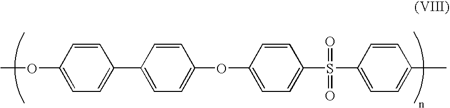

In still other particular examples suitable polyarylsulfones comprise RADEL® R polyphenylsulfone available from Solvay Advanced Polymers, Alpharetta, Ga.

In still other embodiments suitable high temperature thermoplastic resins comprise polyarylene ethers, polyphenylene ethers such as poly(2,6-dimethyl-1,4-phenylene ether), polyphenylene sulfides, polyetheretherketones (PEEK), polyetherketones, polyamideimides, polyethersulfones, polybenzimidazoles, or like materials. Blends comprising at least two thermoplastic resins may also be employed. The resins used in blends are typically either miscible, partially miscible, or compatiblized. Miscible or semi-miscible blends and suitable compatibilization methods are well known in the art. In particular embodiments suitable blends include those comprising either a polyetherimide, a polyarylsulfone, or a polyphenylene ether, such as, but not limited to polyetherimide blends with PEEK, polyetherimide blends with polyphenylene sulfide and polyphenylene ether blends with polystyrene.

In some embodiments thermoplastic resins for use in laminates may optionally comprise one or more conventional additives. Illustrative additives comprise anti-oxidants, flame retardants, ceramic filler, thermally conductive filler, or additives to adjust the dielectric constant of the resin, such as, but not limited to, one or more dielectric adjustment additives selected from metal oxides, illustrative examples of which include aluminum oxide.

In embodiments of the invention suitable metal foils comprise a copper or copper-based alloy. In other particular embodiments suitable metal foils comprise copper, zinc, brass, chrome, nickel, aluminum, stainless steel, iron, gold, silver, titanium or combinations or alloys thereof. In preferred embodiments the metal foil comprises copper. Alternatively, wrought copper foils may be used. In other particular embodiments metal foils comprise an electrically conductive material.

Metal foils in embodiments of the invention typically have a thickness in a range of from about 2 micrometers to about 200 micrometers, preferably in a range of between from about 5 micrometers to about 50 micrometers, and more preferably in a range of between from about 5 micrometers to about 40 micrometers. In other embodiments a metal foil formed on a supporting substrate (carrier), that is, a so-called carrier-borne metal foil, may be used as the above metal foil. A typical carrier-borne metal foil is a copper foil laminated on an aluminum carrier with a parting layer interposed therebetween, which is available commercially. The copper foil may optionally be patterned beforehand by etching with, for instance, an aqueous solution of iron chloride or an aqueous solution of ammonium persulfate. The aluminum carrier may be removed by etching with hydrochloric acid or the like. In some embodiments metal foil, such as, but not limited to, copper foil may optionally be pretreated before use in assembly of the laminates. Illustrative treatment methods for metal foils comprise one or both of chemical treatment such as with a silane, a passivation agent, a cleaning agent, an anti-oxidant, or an etching agent, or physical treatment such as by mechanical cleaning or heat treating.

Suitable fabrics in embodiments of the invention may comprise non-woven fabrics or woven fabrics comprising any of the following glass types: E, D, S, R, or mixtures thereof. Also suitable is NE type glass available from NittoBoseki Co., Fukushima, Japan. Suitable glass styles include, but are not limited to, 106, 1080, 2112, 2113, 2116, and 7628, wherein the term glass style is known to those skilled in the art and refers to the size of glass fibers and number of fibers in a bundle. In other embodiments of the invention fabrics may comprise such materials as aramid such as KEVLAR® aramid available from DuPont, aramid/glass hybrid, or ceramic. In addition, woven fabrics of cellulose fibers can also be used. Fabrics in embodiments of the invention have a thickness of in a range of from about 5 micrometers to about 200 micrometers, preferably in a range of between from about 10 micrometers to about 50 micrometers, and more preferably in a range of between from about 10 micrometers to about 40 micrometers. In some embodiments fabric, such as, but not limited to, woven glass fabric may optionally be pretreated before use in assembly of the laminates. Illustrative treatment methods for fabrics comprise one or both of chemical treatment such as with a sizing agent or a silane, or physical treatment such as by heat, flame, plasma or corona treatment.

Laminates in embodiments of the invention may be made by methods involving one or more steps, such as by using one or more lamination steps. In particular embodiments laminates may be made by thermal lamination under pressure without using thermosetting adhesives. In one particular embodiment a thermoplastic resin film and a layer of fabric are thermally laminated under pressure to form a first laminate, followed by further treatment of the first laminate under heat and pressure with at least one layer of metal foil to form a second laminate. In another particular embodiment a thermoplastic resin film and a layer of metal foil are thermally laminated under pressure to form a first laminate followed by further treatment of the first laminate under heat and pressure with at least one layer of fabric to form a second laminate. In still other particular embodiments a thermoplastic resin film and a layer of metal foil are laminated by a roll-to-roll method or by a solution method in which the thermoplastic is dissolved in a solvent to form a first laminate followed by further treatment of the first laminate under heat and pressure with at least one layer of fabric to form a second laminate. In all cases wherein a first laminate is prepared, the second laminate is prepared by laminating the third layer to the thermoplastic resin side of the first laminate such that the second laminate comprises a layer of thermoplastic resin film between a layer of metal foil and a layer of fabric. In a preferred embodiment thermoplastic resin film is placed between metal foil and a layer of woven fabric, and thermally laminated under pressure in a single step. The thermoplastic resins may be made into films by a typical film extrusion process, and then thermally laminated with woven fabric and metal foil in one step or two consecutive steps by such processes as hot press or roll calendaring methods. In alternative embodiments woven fabric prepregs may be made either by a direct melt extrusion calendering process of thermoplastic resins onto the fabric, or solution suspension prepregging, or dry powder fluidized bed prepregging, or a solution casting prepregging process. The woven fabric prepregs can then be thermally laminated with metal foils. In alternative embodiments a first laminate or a second laminate as described herein may be made by depositing metal onto thermoplastic using a sputtering method or a solution method or an electrolytic method, such as electrodeposition. Such latter methods are particularly useful for providing laminates with very thin layers of metal.

Laminates of the invention may be flexible or semi-flexible (for example, for use in rigid-flex applications). Multilayer laminates comprising additional layers may also be made be thermal lamination in one step or in two or more consecutive steps by such processes as hot press or roll calendaring methods. In some embodiments 7 layers or fewer may be present in the laminate and in other embodiments 16 layers or fewer. For example, in a particular embodiment a laminate may be formed in one step or in two or more consecutive steps with sequential layers of fabric-thermoplastic-metal foil-thermoplastic-fabric-thermoplastic-metal foil or a sub-combination thereof with fewer layers, such that the laminate comprises a layer of thermoplastic resin film between any layer of metal foil and any layer of fabric. In another particular embodiment a first laminate may be formed in one step or in two or more consecutive steps with at least one layer of fabric between two layers of thermoplastic resin, such as a layer of woven glass fabric between two layers of polyetherimide. A second laminate may then be prepared by laminating a metal foil to at least one thermoplastic resin side of the first laminate.

In some embodiments of the invention the combination of thermoplastic and fabric has a coefficient of thermal expansion (CTE) that differs from the CTE of the metal foil by less than about 30 ppm, preferably less than about 15 ppm, and more preferably less than about 10 ppm. In particular embodiments the combination of thermoplastic and fabric has a CTE that differs from the CTE of the metal foil by a value that is in a range of between about 0 ppm and about 30 ppm, preferably in a range of between about 0 ppm and about 15 ppm and more preferably in a range of between about 0 ppm and about 10 ppm. In another embodiment of the invention a two-layer laminate less than or equal to about 98 micrometers in thickness and consisting of a polyetherimide film and a layer of woven glass fabric has a CTE of less than about 45 ppm. In still another embodiment of the invention a three-layer laminate less than or equal to about 98 micrometers in thickness and consisting of a layer of woven glass fabric with a layer of polyetherimide film laminated to each side of the fabric has a CTE of less than about 45 ppm.

Laminates in embodiments of the invention typically have an overall thickness of less than about 4000 micrometers and preferably less than about 1000 micrometers, wherein overall thickness refers to a laminate comprising at least one layer each of metal foil, thermoplastic resin, and fabric. Laminates in some particular embodiments of the present invention have an overall thickness of less than about 500 microns and preferably less than about 300 microns. Laminates in still other particular embodiments of the present invention are flexible and have an overall thickness of less than about 100 micrometers. In other particular embodiments laminates have an overall thickness of less than or equal to about 98 micrometers, preferably of less than about 95 micrometers, more preferably of less than about 80 micrometers, and still more preferably of less than about 50 micrometers. In still other particular embodiments laminates have an overall thickness of less than about 25 micrometers and preferably less than about 15 micrometers. In still other particular embodiments laminates have an overall thickness in a range of between about 10 micrometers and about 98 micrometers, preferably in a range of between about 12 micrometers and about 95 micrometers, and more preferably in a range of between about 15 micrometers and about 50 micrometers. There is no particular limitation on the thickness of the thermoplastic resin film as long as a desired overall thickness of the laminate is achieved. In some embodiments the thickness of the thermoplastic film is in a range of between about 5 micrometers and about 750 micrometers, preferably in a range of between from about 10 micrometers to about 150 micrometers, and more preferably in a range of between from about 10 micrometers to about 100 micrometers.

Articles comprising a laminate made in an embodiment of the invention are another aspect of the invention. Such articles include, but are not limited to, those which typically comprise laminates made of a thermoplastic film such as a polyimide film, an adhesive layer, and a conductive layer such as copper. Other articles include those comprising flex circuits as used in medical or aerospace industries. Still other articles include antennae and like articles. In still other embodiments articles comprising a laminate of the invention comprise multilayer circuit boards for high frequency applications. In other embodiments such articles include, but are not limited to, those comprising FPC, illustrative examples of which comprise cameras, audio and video equipment, office automation equipment. In other embodiments electrical parts may be mounted on FPCs comprising a laminate of the invention, similar to conventional printed circuit boards.

The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples, unless noted differently, polyetherimide was a polymer comprising structural units derived from bisphenol A dianhydride and meta-phenylene diamine with Mw 34,000 and a glass transition temperature of about 217° C. available as ULTEM® 1000 from the General Electric Company. Woven glass fabric was either a plain weave glass fabric 0.025 millimeters (mm) in thickness with warp count 75, fill count 75, and a fabric weight of 17 grams per square meter available as HEXEL® 101 from Hexcel Corporation, Stamford, Conn., or a plain weave glass fabric 0.051 millimeters in thickness available as grade LE50P from St. Gobain Technical Fabrics, Niagara Falls, N.Y. Copper foil was 0.035 mm in thickness obtained from Gould Electronics, Chandler, Ariz. Regarding the radius of curvature data in the tables a plus sign means that the laminate curved toward the polymer film side; a minus sign means that the laminate curved toward the copper foil side.

### COMPARATIVE EXAMPLE 1

Polyetherimide film 0.025 mm in thickness was made using a single screw film extrusion line. The film was laminated with a copper foil using a hot press at 260° C. under 52 megapascals pressure. Pressure was applied after the samples were preheated in the hot press at 260° C. for 5 minutes, followed by an isothermal conditioning period under pressure in the hot press for one minute at 260° C. The pressure was then released and the sample was removed from the hot press, and cooled to room temperature. The polyetherimide/copper laminate displayed a significant amount of curling due to mismatch of CTE between polyetherimide and copper foil.

### EXAMPLE 1

Polyetherimide film was laminated with copper foil using the same conditions described in comparative example 1 except that the polyetherimide film was placed between the copper foil and a single layer of woven glass fabric. Surprisingly, the polyetherimide/copper laminate was perfectly flat, showing that woven glass fabric tremendously improves the dimensional stability of the multi layer composite laminate for such applications as circuit boards.

### EXAMPLES 2-4 AND COMPARATIVE EXAMPLES 2-4

Additional experiments were performed to study the effect of lamination temperature, thermoplastic film thickness, glass transition temperature, and fabric thickness on the curling behavior of the laminate. Table 1 shows data for radius of curvature measurements in centimeters (cm) for laminates prepared as described in either example 1 or comparative example 1 as a function of polyetherimide film thickness.

TABLE 1

Radius of curvature (cm)

| Polyetherimide film | Comparative | |
|---|---|---|
| thickness (mm) | Examples 2-4 | Examples 2-4 |
| 0.025 | +1.9 | flat |
| 0.051 | +1.3 | +3.6 |
| 0.102 | +1.8 | +3.2 |

The data of Table 1 show that the thickness of the polyetherimide film affects the curvature of the final laminate. A flat laminate comprising glass fabric was obtained at 0.025 mm but some curvature was observed at thicker gauges. However, in all cases the laminates of the examples with glass fabric had larger radius of curvature, i.e., were more flat than laminates prepared without glass fabric in the comparative examples.

### EXAMPLES 5-7

Laminates comprising glass fabric were prepared as described in example 1. Table 2 shows the effect of lamination temperature on the radius of curvature for such laminates.

TABLE 2

| Examples | Lamination temperature, ° C. | Radius of curvature (cm) |
|---|---|---|
| 5 | 245 | +6.8 |
| 6 | 260 | flat |
| 7 | 275 | −4.5 |

The radius of curvature data show that a wide range of temperatures is suitable for forming laminates in embodiments of the invention to provide high values for radius of curvature, i.e. acceptable levels of flatness in laminates comprising glass fabric.

### EXAMPLES 8-10 AND COMPARATIVE EXAMPLES 8-10

Laminates were prepared as described in example 1 and comparative example 1 except that a polyetherimide was employed with structural units derived from bisphenol A dianhydride and 4,4′-diaminodiphenylsulfone having a glass transition temperature of 247° C. Table 3 shows the effect of lamination temperature on the radius of curvature for such laminates.

TABLE 3

| | |
|---|---|
| Polyetherimide, Tg 247° C. | Radius of curvature (cm) |

| Lamination temperature, | Comparative | |
|---|---|---|
| ° C. | Examples 8-10 | Examples 8-10 |
| 260 | +1.6 | +4.5 |
| 270 | +1 | +7.1 |
| 290 | +9.1 | −16 |

The data of Table 3 shows that higher Tg polyetherimide film may be employed in embodiments of the invention to provide high values for radius of curvature, i.e. acceptable levels of flatness in laminates comprising glass fabric. In all cases the laminates of the examples with glass fabric had larger radius of curvature, i.e., were more flat than laminates prepared without glass fabric in the comparative examples.

### EXAMPLES 11-14 AND COMPARATIVE EXAMPLES 11-14

Laminates were prepared as described in example 1 and comparative example 1 except that a polyetherimide was employed with structural units derived from 4,4-oxydiphthalic anhydride and 4,4′-diaminodiphenylsulfone having a glass transition temperature of 297° C. Table 4 shows the effect of lamination temperature on the radius of curvature for such laminates.

TABLE 2

Radius of curvature (cm)

| Polyetherimide, Tg 297° C. | Comparative | |
|---|---|---|
| Lamination temperature, | Examples | |
| ° C. | 11-14 | Examples 11-14 |
| 305 | +1.6 | +22.5 |
| 310 | +1.5 | −21.3 |
| 315 | +1.5 | −14.3 |
| 320 | +1.9 | −13.7 |

The data of Table 4 shows that higher Tg polyetherimide film may be employed in embodiments of the invention to provide high values for radius of curvature, i.e., acceptable levels of flatness in laminates comprising glass fabric. In all cases the laminates of the examples with glass fabric had larger radius of curvature, i.e., were more flat than laminates prepared without glass fabric in the comparative examples.

### EXAMPLES 15-16

Laminates were prepared as described in example 1 using polyetherimide with Tg 217° C. Table 5 shows the effect of glass fabric thickness on radius of curvature such laminates.

TABLE 5

| Examples | Glass fabric thickness (mm) | Radius of curvature (cm) |
|---|---|---|
| 15 | 0.025 | flat |
| 16 | 0.051 | −12.2 |

The data of Table 5 show that different glass fabric thicknesses may be employed in embodiments of the invention to provide high values for radius of curvature, i.e. acceptable levels of flatness in laminates comprising glass fabric.

### EXAMPLE 17 AND COMPARATIVE EXAMPLE 15

Laminates were prepared as described in example 1 and comparative example 1 except that an AURUM® polyimide was used having Tg of about 245° C. and a melting temperature (Tm) of 388° C. Table 6 shows data for radius of curvature measurements for such laminates. Laminates in this example were prepared at 280° C. lamination temperature. The abbreviations “Ex.” and C.Ex.” mean “example” and “comparative example”, respectively.

TABLE 6

Radius of curvature (cm)

| Polyimide, Tg 250° C. | C. Ex. 15 without | Ex. 17 with |
|---|---|---|
| thickness (mm) | glass fabric | glass fabric |
| 0.025 | +1.26 | +5.15 |

The data of Table 6 show that radius of curvature can be increased in laminates comprising other high temperature polymers besides polyetherimide to provide acceptable levels of flatness in laminates comprising glass fabric. The laminate of the example with glass fabric had larger radius of curvature, i.e. was more flat, than the laminate prepared without glass fabric in the comparative example.

### EXAMPLE 18 AND COMPARATIVE EXAMPLE 16

A laminate is prepared as described in example 1. For comparison a similar laminate is prepared by a solvent impregnation method as described in European Patent Application 407781. The laminate prepared as described in example 1 exhibits little or no sticking to heated surfaces either during preparation or during subsequent thermal processing. In contrast the laminate prepared by the comparative method exhibits significant sticking to heated surfaces either during preparation or during subsequent thermal processing.

### EXAMPLE 19 AND COMPARATIVE EXAMPLE 17

A first laminate is prepared from polyetherimide film and a single layer of woven glass fabric using a hot press at an effective temperature and pressure. A second laminate is prepared by laminating a layer of metal foil to the thermoplastic resin side of the first laminate. The second laminate has a larger radius of curvature, i.e. is more flat, than a laminate in a comparative example prepared under similar conditions from polyetherimide film and metal foil without glass fabric.

### EXAMPLE 20 AND COMPARATIVE EXAMPLE 18

A first laminate consisting of three layers is prepared from a layer of woven glass fabric and a layer of polyetherimide laminated to each side of the fabric using a hot press at an effective temperature and pressure. A second laminate is prepared by laminating a layer of metal foil to at least one thermoplastic resin side of the first laminate. The second laminate has a larger radius of curvature, i.e. is more flat, than a laminate in a comparative example prepared under similar conditions from polyetherimide film and metal foil without glass fabric.

Laminate preparation methods as described in embodiments of the invention are particularly useful for preparing flexible laminates of less than about 98 micrometers in thickness with substantial diminishing of curling. In the present context substantial diminishing of curling means that the laminate exhibits a greater radius of curvature than a similar laminate prepared without fabric layer. In addition to improved dimensional stability and substantial diminishing or elimination of curling, laminates in embodiments of the invention have good heat resistance, mechanical strength, and flame retardance. The laminates also possess suitable electrical properties such as of low dielectric constant and low dissipation factor for high frequency applications such as in multilayer circuit boards. Another advantage of laminates in embodiments of the invention is the elimination of an adhesive layer from the laminate. Thus, articles comprising the laminates have improved performance in those properties that are adversely affected by the presence of an adhesive, such as in environmental and electrical performance. In addition laminates prepared by the process as described in example 1 exhibit little or no sticking to heated surfaces during thermal processing steps because the thermoplastic resin as the center layer in the three-component laminate has not thoroughly impregnated the fabric, as opposed to similar laminates made by a solvent impregnation method, wherein thermoplastic resin may be to a more significant degree on the outside of the fabric and subject to softening and sticking to heated surfaces.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and published articles cited herein are incorporated herein by reference.

1. A method for preparing a laminate less than or equal to about 98 micrometers in thickness and having substantially diminished curling which comprises the steps of (i) providing a metal foil, a thermoplastic resin film and a woven fabric, and (ii) laminating the thermoplastic resin film between the metal foil and woven fabric, wherein the combination of thermoplastic and fabric has a coefficient of thermal expansion that differs from the coefficient of thermal expansion of the metal foil by less than about 30 ppm.

2. The method of claim 1, wherein the laminate is prepared in a single step by laminating under heat and pressure.

3. The method of claim 1, wherein a first laminate is prepared by laminating under heat and pressure the thermoplastic resin film and the woven fabric, and a second laminate is prepared by laminating the metal foil to the thermoplastic resin side of the first laminate.

4. The method of claim 1, wherein a first laminate is prepared by laminating the thermoplastic resin film and the metal foil, and a second laminate is prepared by laminating the woven fabric to the thermoplastic resin side of the first laminate.

5. The method of claim 4, wherein the first laminate is prepared by a roll-to-roll, electrodeposition, or sputtering method and the second laminate is prepared by laminating under heat and pressure.

6. The method of claim 1, wherein the metal foil is selected from the group consisting of copper, zinc, brass, chrome, nickel, aluminum, stainless steel, iron, gold, silver, titanium, combinations thereof, and alloys thereof.

7. The method of claim 1, wherein the metal foil comprises copper.

8. The method of claim 1, wherein the woven fabric comprises at least one of glass types E, D, S, R, NE, or mixtures thereof, or an aramid, an aramid/glass hybrid, or a ceramic.

9. The method of claim 1, wherein the thermoplastic resin is selected from the group consisting of polyetherimides, polyetherimide blends with polyphenylene sulfide, polyetherimide blends with polyetheretherketone, polyimides, polyarylsulfones, polyetheretherketones, polyetherketones, polyarylene ethers, polyphenylene ethers, poly(2,6-dimethyl-1,4-phenylene ether), polyphenylene ether blends with polystyrene, polyphenylene sulfides, polyamideimides, polyethersulfones, and polybenzimidazoles.

10. The method of claim 1, wherein the thermoplastic resin is a polyetherimide or a blend of thermoplastic resins comprising polyetherimide.

11. The method of claim 1, wherein the combination of thermoplastic and fabric has a coefficient of thermal expansion that differs from the coefficient of thermal expansion of the metal foil by less than about 15 ppm.

12. A method for preparing a laminate less than or equal to about 98 micrometers in thickness and having substantially diminished curling which comprises the step of laminating under heat and pressure a polyetherimide resin film between a layer of copper foil and a layer of woven glass fabric, wherein the combination of polyetherimide and fabric has a coefficient of thermal expansion that differs from the coefficient of thermal expansion of the copper foil by less than about 30 ppm.

13. A laminate made by the method of claim 1.

14. A laminate made by the method of claim 12.

15. A laminate less than or equal to about 98 micrometers in thickness and having substantially diminished curling comprising a thermoplastic resin film between a layer of metal foil and a layer of woven fabric, wherein the combination of thermoplastic and fabric has a coefficient of thermal expansion that differs from the coefficient of thermal expansion of the metal foil by less than about 30 ppm.

16. The laminate of claim 15, wherein the metal foil is selected from the group consisting of copper, zinc, brass, chrome, nickel, aluminum, stainless steel, iron, gold, silver, titanium, combinations thereof, and alloys thereof.

17. The laminate of claim 15, wherein the metal foil comprises copper.

18. The laminate of claim 15, wherein the woven fabric comprises at least one of glass types E, D, S, R, NE, or mixtures thereof, or an aramid, an aramid/glass hybrid, or a ceramic.

19. The laminate of claim 15, wherein the thermoplastic resin is selected from the group consisting of polyetherimides, polyetherimide blends with polyphenylene sulfide, polyetherimide blends with polyetheretherketone, polyimides, polyarylsulfones, polyetheretherketones, polyetherketones, polyarylene ethers, polyphenylene ethers, poly(2,6-dimethyl-1,4-phenylene ether), polyphenylene ether blends with polystyrene, polyphenylene sulfides, polyamideimides, polyethersulfones, and polybenzimidazoles.

20. The laminate of claim 15, wherein the thermoplastic resin is a polyetherimide or a blend of thermoplastic resins comprising polyetherimide.

21. The laminate of claim 15, wherein the combination of thermoplastic and fabric has a coefficient of thermal expansion that differs from the coefficient of thermal expansion of the metal foil by less than about 15 ppm.

22. A laminate less than or equal to about 98 micrometers in thickness and having substantially diminished curling comprising a polyetherimide resin film between a layer of copper foil and a layer of woven glass fabric, wherein the combination of polyetherimide and fabric has a coefficient of thermal expansion that differs from the coefficient of thermal expansion of the copper foil by less than about 30 ppm.

23. An article comprising the laminate of claim 22.

24. A flexible printed circuit comprising the laminate of claim 22.

25. A two-layer laminate less than or equal to about 98 micrometers in thickness consisting of a polyetherimide film and a layer of woven glass fabric, and having a CTE of less than about 45 ppm.

26. A three-layer laminate less than or equal to about 98 micrometers in thickness consisting of a layer of woven glass fabric with a layer of polyetherimide film laminated to each side of the fabric, and having a CTE of less than about 45 ppm.
